(19) United States
(12) Patent Application Publication
(10) Pub. No.: US 2005/0256904 A1
(43) Pub. Date: Nov. 17, 2005

(54) Reading data from physical items

(76) Inventor: Aurobinda Pradhan, Bangalore (IN)

Correspondence Address: FISH & RICHARDSON, P.C., PO BOX 1022, MINNEAPOLIS, MN, 55440-1022, US

(21) Appl. No.: 10/841,007

(22) Filed: May 7, 2004

(51) Int. Cl. G06F 17/00

(52) U.S. Cl. 707/104.1

(57) ABSTRACT

Data affixed to a selected physical item is read in a process of reading data affixed to multiple physical items. A method comprises receiving in a computer system first data that is read from a selected physical item of a plurality of physical items. The first data is displayed in an editing area of a graphical user interface and not in a list display area of the graphical user interface. Upon receiving second data that is read from another selected physical item, 1) the first data ceases to be displayed in the editing area, 2) the first data is displayed in the list display area, and 3) the second data is displayed in the editing area. The reading can be performed using a handheld barcode scanner.

### TECHNICAL FIELD

This description relates to reading data portions that are affixed to physical items.

### BACKGROUND

The increasing use of computers has simplified some tasks that used to be rather time-consuming, for example inventory management. There exists several techniques for affixing machine-readable information to products, boxes, pallets, warehouse shelves, shipping containers or other units used in the everyday business of manufacturers, distributors, whole sellers and others. For example, scanners for reading barcode labels and detectors for radio frequency identification (RFID) tags can be used for these purposes. Typically the affixed information includes some identity of the item being labeled, such as a product, and sometimes quantity information or other relevant data. In the transportation industry, the affixed label or tag can include the full shipping particulars, such as the names and address of the sender and recipient. More commonly, perhaps, the label may include a unique identifier that can be used to look up an electronic record stored in the company's database.

Thus, the reading of information affixed to products or other units can be done automatically with a scanner or other detector connected to a computer. This does not always eliminate the need for human assistance in the process, however. For example, a person may need to operate a handheld barcode scanner to read labels on selected cartons in a warehouse. The user sometimes chooses to scan some items but not others. This sometimes leads to mistakes, such as inadvertently scanning the wrong item or scanning the same item twice. Moreover, there is sometimes a need to register information other than that encompassed by the label or tag. In inventory management, for example, it may be of interest to record not only the type and quantity of products stored at a location, but also whether they appear to have been damaged, which may affect the value of the inventory.

Accordingly, a person's participation in the process of reading data from items may require that person to manipulate the data that has been read. For example, the person may wish to delete the data that was scanned by mistake, or edit data that the person realizes is incorrectly coded on the label. Also, the person may need to add information to the record of a scanned item, for example to register its condition or other circumstances observed at the time. User intervention may be facilitated by a user interface between the person and the computer system, such as a graphical user interface (GUI) on a handheld barcode scanner.

Existing systems for automatic reading of labels or tags may have disadvantages in these and other regards. This may affect the overall quality or efficiency of the label reading, particularly when the person is scanning a large number of items. For example, an existing system may not offer a convenient way for the user to review the data from the most recently scanned item before it is added to a master list of scanned data. As another example, existing systems may not permit convenient editing of, or adding of information to, the scanned data. Particularly, it may be inconvenient and time-consuming for the person to review the entire master list of scanned data to identify the most recently scanned item.

### SUMMARY

The invention relates to reading data from physical items. In a first general aspect, a method comprises of reading data affixed to a selected physical item in a process of reading data affixed to multiple physical items comprises receiving in a computer system first data that is read from a selected physical item of a plurality of physical items. The first data is displayed in an editing area of a graphical user interface and not in a list display area of the graphical user interface. Upon receiving second data that is read from another selected physical item, 1) the first data ceases to be displayed in the editing area, 2) the first data is displayed in the list display area, and 3) the second data is displayed in the editing area.

In selected embodiments, there is received while the second data is being displayed in the editing area a user input to delete the second data from the computer system. Upon receiving the user input, the second data may cease to be displayed in the editing area.

In selected embodiments, there is received, after the user input is received, third data that is read from yet another selected physical item. The third data may be displayed in the editing area and not displayed in the list display area.

In selected embodiments, an editing input is received from a user while the first data is being displayed in the editing area. The editing area may include multiple input fields. The editing input may be made in one of the input fields that is not initially filled using the first data. The editing input may be made in one of the input fields that is initially filled using the first data. The editing input may be based on an observation made by a user that handles the reading of at least the first data.

In a second general aspect, a graphical user interface for reading data affixed to a selected physical item in a process of reading data affixed to multiple physical items comprises an editing area in which first data that is read from a selected physical item of a plurality of physical items is displayed, and a list display area in which the first data is displayed upon receipt of second data that is read from another selected physical item, wherein the first data is no longer displayed in the editing area and wherein the second data is displayed in the editing area.

Advantages of the systems and techniques described herein may include any or all of the following. Improved reading of data from physical items. Improved editing of data read from a physical item. Providing that a user can conveniently add information to data that is scanned from a particular item. Providing the user a chance to edit, enhance or remove data read from a selected item before it is added to a master list. Providing a GUI with a two-stage data presentation process for data acquisition from multiple physical items.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 schematically illustrates an example of performing inventory management;

FIGS. 2A-B are examples of a GUI that can be presented during inventory management;

FIGS. 3-5 are flow charts of embodiments of an inventive method; and

FIG. 6 is a block diagram of a general computer system.

Like reference numerals in the various drawings indicate like elements.

### DETAILED DESCRIPTION

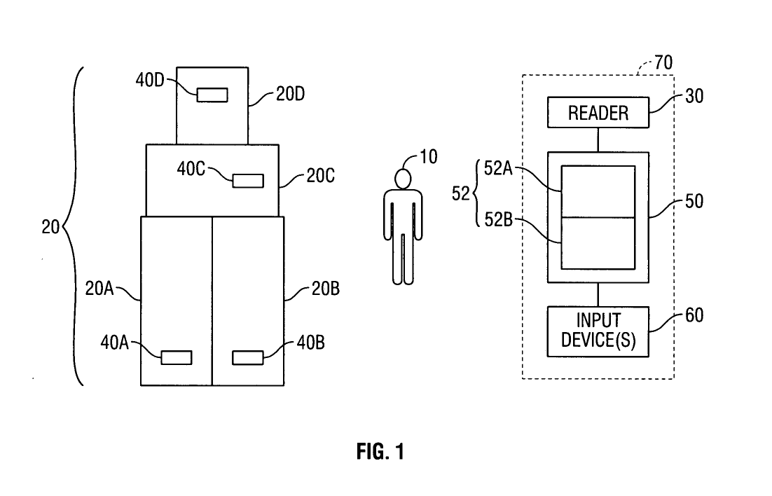

FIG. 1 is an example of inventory management where a person 10 wishes to register the presence of physical items 20, such as a pallet load of cartons. This scenario may take place in a warehouse, delivery van or a retail facility, to name just a few examples. The user 10 uses a reader 30 to automatically read data that is affixed to the physical items by attachments 40A-D. For example, the attachments can comprise barcode labels or RFID tags. As another example, the attachments may be information printed on the products without a label or tag being applied. The person may obtain the reading by bringing the reader near one of the items or its attachment. As another example, the person may bring the items near the reader. The data read from an item may first be displayed in an editing area and thereafter, upon the scanning of the next item, moved to a list display area.

A display device 50 is connected to the reader. A GUI 52 can be presented on the display device to aid the person's task of performing the inventory management. The GUI 52 may include an editing area 52A and a list display area 52B. The user may make inputs with input device(s) 60 connected to the display device. For example, the input device may let the user edit, enhance or delete data that is read from one or more of the physical items.

The reader 30, display device 50 and input device 60 may be directly connected to a remote computer system (not shown) where the acquired data is to be received and stored. Such a connection may be established using a cable connected to a suitable computer port. In such an implementation, there may be virtually no delay between when data is read and when it is received by the system. As another example, the reader, display device and input device may be incorporated into a handheld computer system 70 (shown in phantom), such as a barcode scanner. In such implementations, the handheld system may normally be offline and periodically upload acquired data to the remote system by a wireless connection or by the device being temporarily connected to a network computer. Accordingly, the person in this example uses the reader to read data that is affixed to the physical items, for the purpose of performing inventory management.

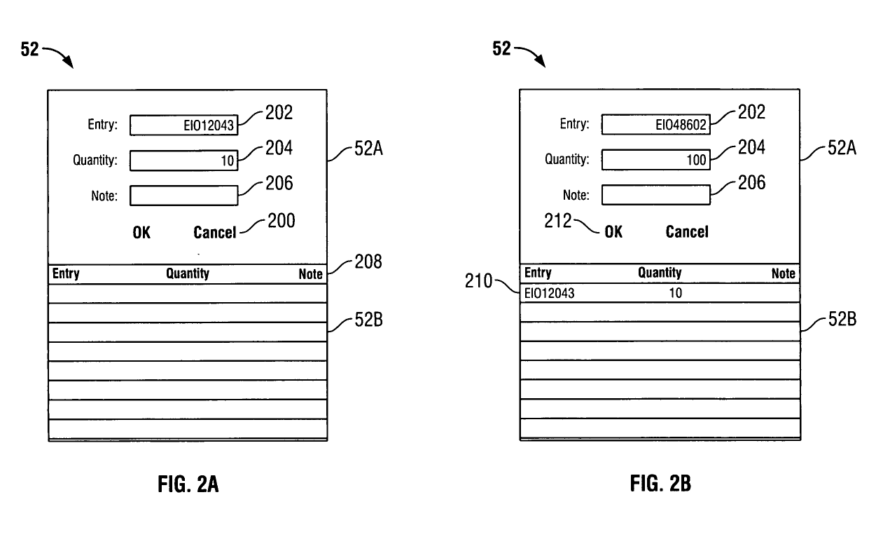

FIGS. 2A-B are examples of the GUI 52 that can be presented to the person during the inventory management. Upon reading data from the physical item 20A, for example, the read data is first displayed in editing area 52A. The user can edit, enhance or delete the data in the editing area. The data can be deleted using “Cancel” input command 200. For example, the user may wish to delete the read data if the reading occurred by mistake, such as by inadvertently scanning the wrong item or scanning the same item twice.

The editing area includes an “Entry” input field 202, a “Quantity” input field 204 and a “Note” input field 206 for displaying data read from an item. The “Entry” field may contain an identifier associated with the item 20A, here EIO12043, which may be the identity of the physical item 20A or, when the item is merely a container for other items, the identity or identities of those items. The “Quantity” field may contain information about the number of units included in the item 20A, here 10. The “Note” field may contain additional data relating to the item 20A, such as a manufacturer name, sender or recipient name, delivery date or special instructions for its maintenance. Particularly, the “Note” input field may let the person add information about the item 20A that is not included in the attachment 40A. Such added information may be based on an observation that the person makes when performing the inventory management. For example, when the item 20A is labeled “Keep Frozen,” the person may edit the field 206 to note that the item currently is exposed to room temperature conditions. As another example, the person may note that the item 20A appears to be leaking water. Editing may be done by making suitable inputs with the input device(s) 60, such as selecting one of the fields 202-206 and typing desired characters.

The GUI 52 also may include the list display area (LDA) 52B. In FIG. 2A, physical item 20A was the first one scanned, so LDA 52 is currently empty in this example. Data acquired from physical items may be displayed in list form in LDA, for example, as rows, under a title bar 208. Here, the title bar has headings corresponding to the input fields 202, 204 and 206. Accordingly, when data from a next item is read, the data currently displayed in the editing area may instead be displayed under appropriate headings in the LDA.

Assume that, without first deleting or changing the data read from item 20A, the person uses the reader to acquire data from the next item, say physical item 20B. The data from item 20A may then cease to be displayed in the editing area. Instead, the data from item 20A may be displayed on a first row 210 of the LDA. The data from item 20B may be displayed in the editing area. Here, the “Entry” value for item 20B is EIO48602 and the quantity is 100. The person may delete, edit or enhance the data from item 20B while it is displayed in the editing area, for example by adding information in field 206. An “OK” input command 210 may let the person move contents from the editing area to the LDA without (or before) scanning a next item. That is, when data read from an item is displayed in the editing area (and optionally edited), an input made by selecting the command 210 may cause the read data to cease being displayed in the editing area, and instead be displayed in the LDA (together with any other item data that may be there). The field(s) in the editing area may be empty following this operation.

Data acquisition from multiple RFID tags can take place essentially simultaneously. If it is desired to selectively register data from particular items in such cases, one may choose the operating characteristics of one or more system components accordingly. For example, a signal transmitted from an RFID tag will attenuate over distance, such that it essentially cannot be detected beyond a maximum perimeter. Moreover, the sensitivity of an RFID receiver incorporated in the system will effect how remotely it can detect items.

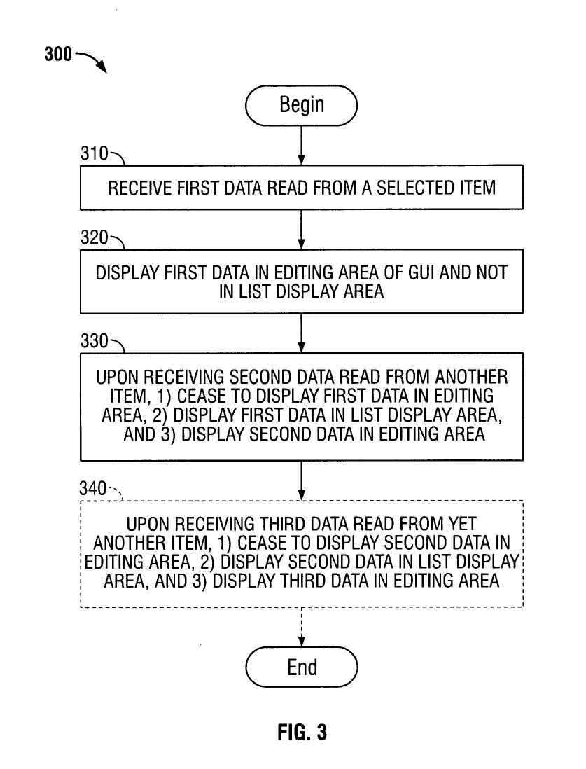

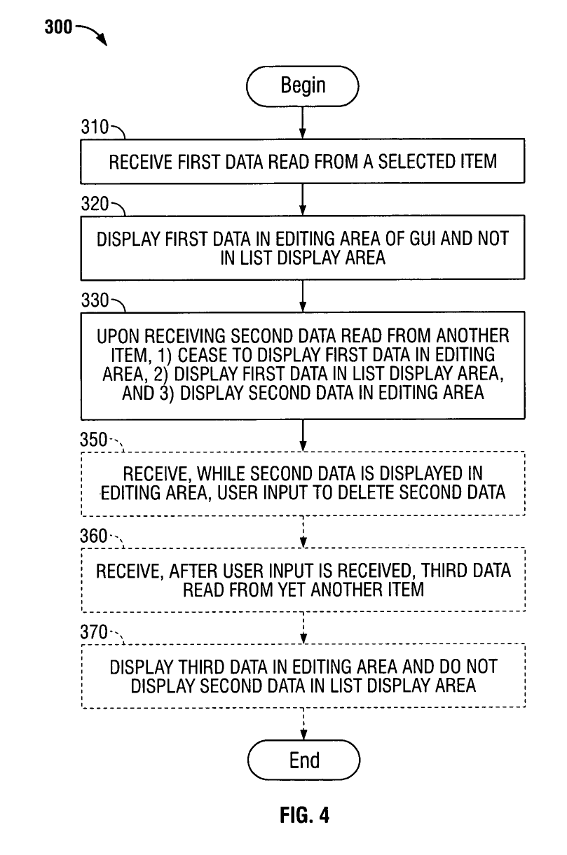

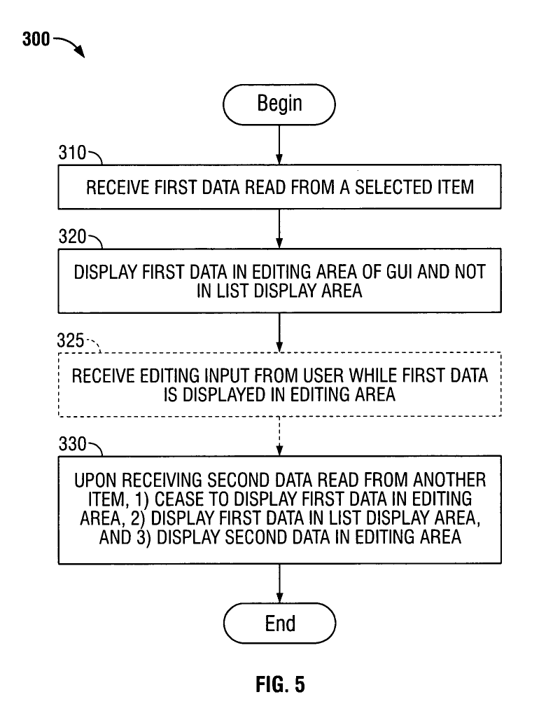

FIGS. 3-5 are flow charts of embodiments of an inventive method. Particularly, the flow chart in FIG. 3 is a method 300 wherein a person causes data to be read from two items and thereafter, optionally, causes data to be read from a third item. FIG. 4 is a flow chart of the method 300 where data is reaf from the two items and thereafter the person optically deletes the data read from the second item while it is being displayed in the editing area. FIG. 5, in turn, is a flow chart of the method 300 where data is read from the first item, the person then optionally edits that data, and finally data is read from a second item. Preferably, any or all of the embodiments of method 300 are performed in a computer system. For example, a computer program product can include executable instructions that cause a processor to perform the method steps of any embodiment.

The flow chart shown in FIG. 3 includes the following steps:

Receiving, in step 310, first data in a computer system. The first data is read from a selected physical item of a plurality of physical items. For example, the person 10 may use reader 30 to read data from the physical item 20A. Particularly, the data may be read from attachment 40A, such as a barcode.

Displaying, in step 320, the first data in an editing area of a graphical user interface and not in a list display area of the graphical user interface. For example, the data read from item 20A may be displayed in editing area 52A and may not be displayed in LDA 52B. For example, the editing area 52A may include input fields 202-206 wherein the read data is displayed.

In step 330, and upon receiving second data that is read from another selected physical item, 1) ceasing to display the first data in the editing area, 2) displaying the first data in the list display area, and 3) displaying the second data in the editing area. For example, upon receiving the data read from physical item 20B, the data from item 20A may cease to be displayed in the editing area, the item 20A data may be displayed in the LDA, and the data from the item 20B may be displayed in the editing area 52A. In this example, the person does not change or delete the item 20A data in the editing area.

Rather, the person may continue the inventory management. Upon receiving third data that is read from yet another selected physical item, optional step 340 may be performed. Step 340 includes 1) ceasing to display the second data in the editing area, 2) displaying the second data in the list display area, and 3) displaying the third data in the editing area. For example, the person 10 may use reader 30 to read data from the next physical item, such as item 20C. Particularly, the data may be read from attachment 40C. Upon receiving the item 20C data, the item 20B data may cease to be displayed in the editing area, the item 20B data may be displayed in the LDA, and the item 20C data may be displayed in the editing area 52A.

The flow chart in FIG. 4 includes the following steps:

Steps 310, 320 and 330 may be performed substantially as described above with reference to FIG. 3.

In optional step 350, however, and while the second data is being displayed in the editing area, there may be received user input to delete the second data from the computer system. For example, the person 10 may activate the “Cancel” command 200 while the data read from physical item 20B is being displayed in the editing area. Activation of this command may cause a predetermined user input to be made in the computer system, the input indicating that the second data is to be deleted. The second data may cease to be displayed in the editing area upon receipt of the user input. For example, the input fields 202-206 may be cleared of data upon the user clicking the “Cancel” command.

Receiving, in optional step 360, and after the user input is received, third data that is read from yet another selected physical item. For example, the person 10 may use reader 30 to read data from the next physical item, such as item 20C.

Displaying, in optional step 370, the third data in the editing area and not displaying the second data in the list display area. For example, upon receiving the item 20C data, it may be displayed in the editing area 52A. The item 20B data, which was deleted in this example, is not displayed in the LDA.

The flow chart in FIG. 5 includes the following steps:

Steps 310 and 320 may be performed substantially as described above with reference to FIG. 3.

In optional step 325, however, and while the first data is being displayed in the editing area, there is received an editing input from a user. For example, the person 10 may enter or delete information in any of input fields 202-206. When, as in this example, the editing area includes multiple input fields, the person may make the editing input in one of the input fields that is not initially filled using the first data, such as in the field 206 in the exemplary FIG. 2A. As another example, the person may make the editing input in one of the input fields that is initially filled using the first data, such as in the field 204 of the exemplary FIG. 2A. Editing input may be based on an observation made by a user that handles the reading of at least the first data, for example, something about the physical item 20A that the person noties while performing the inventory management.

Step 330 may thereafter be performed substantially as described above with reference to FIG. 3.

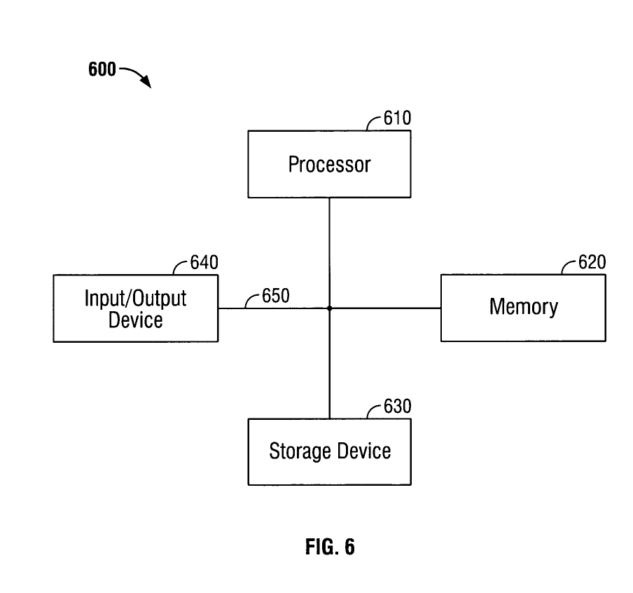

FIG. 6 is a block diagram of a computer system 600 that can be used in the operations described above, according to one embodiment. The system 600 includes a processor 610, a memory 620, a storage device 630 and an input/output device 640. Each of the components 610, 620, 630 and 640 are interconnected using a system bus 650. The processor 610 is capable of processing instructions for execution within the system 600. In one embodiment, the processor 610 is a single-threaded processor. In another embodiment, the processor 610 is a multi-threaded processor. The processor 610 is capable of processing instructions stored in the memory 620 or on the storage device 630 to display graphical information for a user interface on the input/output device 640.

The memory 620 stores information within the system 600. In one embodiment, the memory 620 is a computer-readable medium. In one embodiment, the memory 620 is a volatile memory unit. In another embodiment, the memory 620 is a non-volatile memory unit.

The storage device 630 is capable of providing mass storage for the system 600. In one embodiment, the storage device 630 is a computer-readable medium. In various different embodiments, the storage device 630 may be a floppy disk device, a hard disk device, an optical disk device, or a tape device.

The input/output device 640 provides input/output operations for the system 600. In one embodiment, the input/output device 640 includes a keyboard and/or pointing device. For example, the device 640 may include the input device(s) 60 shown in FIG. 1. In one embodiment, the input/output device 640 includes a display unit for displaying graphical user interfaces. For example, the device 640 may include the display device 50 shown in FIG. 1. As another example, the device 640 may include the reader 30 shown in FIG. 1.

The invention can be implemented in digital electronic circuitry, or in computer hardware, firmware, software, or in combinations of them. Apparatus of the invention can be implemented in a computer program product tangibly embodied in an information carrier, e.g., in a machine-readable storage device or in a propagated signal, for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the invention can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The invention can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. Accordingly, other embodiments are within the scope of the following claims.

1. A method of reading data affixed to a selected physical item in a process of reading data affixed to multiple physical items, the method comprising:
receiving in a computer system first data that is read from a selected physical item of a plurality of physical items;
displaying the first data in an editing area of a graphical user interface and not in a list display area of the graphical user interface; and
upon receiving second data that is read from another selected physical item, 1) ceasing to display the first data in the editing area, 2) displaying the first data in the list display area, and 3) displaying the second data in the editing area.

2. The method of claim 1, wherein the first data is included in a barcode affixed to the selected physical item.

3. The method of claim 1, wherein the first data is read from the selected physical item using a character recognition technique.

4. The method of claim 1, wherein reading the first data and second data is part of inventory management of the multiple physical items.

5. The method of claim 1, wherein the computer system is incorporated in a handheld device.

6. The method of claim 5, wherein the handheld device scans barcodes affixed to the multiple physical items and wherein the first data and second data are included in the barcodes.

7. The method of claim 1, further comprising receiving, while the second data is being displayed in the editing area, a user input to delete the second data from the computer system.

8. The method of claim 7, further comprising ceasing to display the second data in the editing area upon receiving the user input.

9. The method of claim 7, further comprising:
receiving, after the user input is received, third data that is read from yet another selected physical item; and
displaying the third data in the editing area and not displaying the second data in the list display area.

10. The method of claim 1, further comprising receiving an editing input from a user while the first data is being displayed in the editing area.

11. The method of claim 10, wherein the editing area includes multiple input fields and wherein the editing input is made in one of the input fields that is not initially filled using the first data.

12. The method of claim 10, wherein the editing area includes multiple input fields and wherein the editing input is made in one of the input fields that is initially filled using the first data.

13. The method of claim 10, wherein the editing input is based on an observation made by a user that handles the reading of at least the first data.

14. A computer program product tangibly embodied in an information carrier, the computer program product including instructions that, when executed, cause a processor to perform instructions comprising:
receive in a computer system first data that is read from a selected physical item of a plurality of physical items;
display the first data in an editing area of a graphical user interface and not in a list display area of the graphical user interface; and
upon receiving second data that is read from another selected physical item, 1) cease to display the first data in the editing area, 2) display the first data in the list display area, and 3) display the second data in the editing area.

15. A computer program product tangibly embodied in an information carrier, the computer program product including instructions that, when executed, generate on a display device a graphical user interface for reading data affixed to a selected physical item in a process of reading data affixed to multiple physical items, the graphical user interface comprising:
an editing area in which first data that is read from a selected physical item of a plurality of physical items is displayed; and
a list display area in which the first data is displayed upon receipt of second data that is read from another selected physical item, wherein the first data is no longer displayed in the editing area and wherein the second data is displayed in the editing area.
